(19) United States
(12) Patent Application Publication
(10) Pub. No.: US 2016/0286605 A1
(43) Pub. Date: Sep. 29, 2016

(54) Methods and Means for Radio Bearer Release

(71) Applicant: TELEFONAKTIEBOLAGET LM ERICSSON (PUBL), Stockholm (SE)

(72) Inventors: Lotta Voigt, Bromma (SE); Ann-Christine Eriksson, Enköping (SE)

(21) Appl. No.: 15/037,496

(22) PCT Filed: Nov. 19, 2013
(86) PCT No.: PCT/SE2013/051353

§ 371 Date: May 18, 2016

(51) Int. Cl. H04W 76/06

(52) U.S. Cl. CPC H04W 76/064; H04W 76/068

(57) ABSTRACT

The present disclosure concerns radio communication. More particularly, the present disclosure inter alia introduces methods and means for improved radio access bearer (RAB) release, particularly in situations when there is a RAB limitation requirement. According to one embodiment, a method is performed by a radio network node. The radio network node is handling a set of RABs. This set of RABs consists of one or more RABs. Information related to each RAB of the set of RABs is obtained (130). The obtained information is processed (140) to generate a predicted timing of a next data transmission for each RAB. Also, a ranking is determined (150) for each RAB. This ranking is determined based on the predicted timing. Furthermore, a subset of the set of RABs is selected (160) based on the determined ranking. The subset of the set of RABs is selected (160) in such way that a cardinality of the selected subset complies with a RAB limitation requirement. Finally, any RAB of the set of RABs which is not in the selected subset is released (170), whereas any RAB of the set of RABs which is in the selected subset is kept (180).

### TECHNICAL FIELD

The technology presented in this disclosure generally relates to radio communication networks and, more particularly, to radio access bearer (RAB) release within such radio communication networks. The present disclosure will focus on RAB release in Wideband Code Division Multiple Access (WCDMA). However, persons skilled in the art will appreciate that the technology presented in this disclosure is equally applicable to E-RAB release in e.g. Long Term Evolution (LTE).

### BACKGROUND

This section is intended to provide a background to the various embodiments of the technology that are described in this disclosure. The description herein may include concepts that could be pursued, but are not necessarily ones that have been previously conceived or pursued. Therefore, unless otherwise indicated herein, what is described in this section is not prior art to the description and/or example embodiments of this disclosure and is not admitted to be prior art by the mere inclusion in this section.

Radio communication networks are widely deployed to provide various communication services such as telephony, video, data, messaging, broadcasts, and so on. Such communication networks support communications for multiple user equipments (UEs) by sharing the available network resources. One example of such a network is the Universal Mobile Telecommunications System (UMTS), a third generation (3G) mobile phone technology standardized by the 3rd Generation Partnership Project (3GPP). UMTS includes a definition for a Radio Access Network (RAN), referred to as UMTS Terrestrial Radio Access Network (UTRAN). The UMTS, which is the successor to Global System for Mobile Communications (GSM) technologies, supports various air interface standards, such as WCDMA, Time Division Code Division Multiple Access (TDCDMA), and Time Division Synchronous Code Division Multiple Access (TDSCDMA). The UMTS also supports enhanced 3G data communications protocols, such as High Speed Packet Access (HSPA), which provides higher data transfer speeds and capacity to associated UMTS networks. As the demand for mobile broadband access continues to increase, research and development continue to advance the UMTS technologies not only to meet the growing demand for mobile broadband access, but to advance and enhance the user experience with mobile communications. For example, third-generation UMTS based on WCDMA has been deployed in many places of the world. To ensure that this system remains competitive in the future, 3GPP began a project to define the long-term evolution of UMTS cellular technology. The specifications related to this effort are formally known as Evolved UMTS Terrestrial Radio Access (E-UTRA) and Evolved UMTS Terrestrial Radio Access Network (E-UTRAN), but are more commonly referred to by the name LTE.

One purpose of the WCDMA RAN is to provide a connection between the UE and the core network (CN) and to isolate all the radio issues from the core network. One core network can thus support various access technologies. The WCDMA RAN generally comprises two types of nodes:
The Radio Base Station (often referred to as Node B (NB)) handles the radio transmission and reception to/from the UE over the radio interface. It is controlled from the Radio Network Controller (RNC). One NB can handle one or more radio cells.
The Radio Network Controller (RNC) controls WCDMA RAN functions. It connects the WCDMA RAN to the CN. There exist two distinct roles for the RNC, to serve and to control. The Serving RNC has overall control of the UE that is connected to WCDMA RAN. It controls the connection for the UE and it terminates several protocols in the contact between the UE and the WCDMA RAN. The Controlling RNC has the overall control of a particular set of cells, and their associated base stations. When a UE requires resources in a cell that are not controlled by its Serving RNC, the Serving RNC must ask the Controlling RNC for those resources.

A main service offered by a WCDMA RAN is the provision of the Radio Access Bearer (RAB). To establish a call connection between the UE and the NB a RAB is needed.

The characteristics of the RABs are different depending on what kind of service and/or information is to be transported. The RAB carries the user data between the UE and the core network. The 3GPP has defined different quality classes of RABs:
Conversation (e.g. voice telephony): low delay, strict ordering Streaming (e.g. for watching a video clip): moderate delay, strict ordering Interactive (e.g. web browsing and web surfing): moderate delay Background (e.g. for file transfer): no delay requirement.

A RAB has certain Quality of Service (QoS) parameters, such as bit rate and delay. The CN will select a RAB with appropriate QoS based on the service request from the subscriber, and ask the RNC to provide such a RAB.

### WCDMA Radio Access Network

Transfer of packet data units (PDUs) between a UE and a packet data provider network is achieved by means of the GTP (GPRS (General Packet Radio System) Tunneling Protocol) protocol. The tunneling protocol utilizes encapsulation of Internet packets in GTP packets. The tunneling is setup via so-called Packet Data Protocol (PDP) contexts, which exist in the UEs, the SGSN (Serving GPRS Support Node) and the GGSN (Gateway GPRS Support Node). Moreover, the service characteristics of the transmission of PDU are controlled according to the established PDP context. In order to transmit or receive data the UE must be in connected mode, inferring that a “radio connection” is established between the UE and the NB and a PDP context is activated. More detailed information about the PDP context, e.g. activation, modification, deactivation, preservation, etc. can be found in the 3GPP Technical Specification 3GPP TS 23.060, V.12.2.0 (2013-09), see e.g. section 9.2. According to the known procedure, the UE sends an Activate PDP Context Request message to the SGSN at power-on or upon activation of a specific service. The SGSN in turn evaluates the request and selects a GGSN to which it sends a Create PDP Context Request. The GGSN replies with a Create PDP Context Response to the SGSN if the evaluation is affirmative. Normally, the PDP Context is activated when the user initiates a service, e.g. sends an MMS (Multimedia Messaging Service). However, some operators have an always-on principle that means that the UE activates the PDP Context when they are powered-on. Thereafter, the SGSN performs a RAB setup procedure. On the other hand, if the GGSN sends a negative response, the SGSN sends an Activate PDP Context Reject message to the UE. The GGSN responds by sending a Create PDP Context Response to the SGSN. Depending on the outcome of the RAB setup procedure, the SGSN sends an Activate PDP Context Accept message if the RAB setup was successful or an “Activate PDP Context Reject message if the RAB set-up failed.

### SUMMARY

In WCDMA, there exist scenarios when there exists a RAB limitation requirement, i.e. a requirement that sets a limitation on the number of RABs. For example, the RAB limitation requirement may be a limitation on the number of RABs that can be set up for the UE. As one example, the supported number of RABs can be different for different Radio Resource Control (RRC) states. Generally, multiple RABs are not necessarily supported in lower RRC states. However, implementation of NBs and UEs can be done in such way that comparatively more RABs are supported in higher RRC states. Consequently, when a supported number of RABs per UE in Cell_DCH (dedicated channel) exceeds the number of RABs that is supported in Cell_FACH (forward access channel), Cell_PCH (cell paging channel) and/or URA PCH (UTRAN registration area cell paging channel), a decision generally has to be made as to which RAB or RABs to keep and which RABs to release when the UE performs a state transition from Cell_DCH to Cell_FACH, Cell_PCH or URA_PCH. In such scenario, one or more RABs have to be released at a UE state transition from a higher RRC state, e.g. Cell_DCH, to a lower RRC state, e.g. Cell_FACH. Which RAB(s) to release at state transition to lower RRC states and which RAB(s) to keep is often decided by inactivity timers in the existing art. In this way the RAB(s) with the last data activity will generally be kept when switching, or changing, to lower RRC states. However, it is not necessarily the case that the next data transmission will occur on the kept RAB(s). If not, unnecessary latency and signaling may be added for setting up the actual RAB before the new data transmission can occur, i.e. take place.

It is in view of the above considerations and others that the various embodiments disclosed herein have been made.

In one of its aspects, the technology disclosed herein therefore concerns a method for controlling radio access bearer (RAB) release. The method is performed by, or otherwise implemented or executed in, a radio network node. The radio network node is handling a set of RABs. This set of RABs consists of one or more (i.e. several) RABs for providing communication service to a User Equipment (UE). Or said differently, the radio network node can be said to handle a number of UEs, where each UE has an associated set of RABs. Thus, the radio network node handles a set of RABs.

Information related to each RAB of the set of RABs is obtained. The thus obtained information is processed to generate a predicted timing of a next data transmission for each RAB of the set of RABs. Also, a ranking is determined for each RAB of the set of RABs. This ranking is determined based on the earlier-mentioned predicted timing. Furthermore, a subset of the set of RABs is selected based on the determined ranking. The subset of the set of RABs is selected in such way that a cardinality of the selected subset complies with a RAB limitation requirement. That is, the subset of the set of RABs is selected in such way that a number of RABs of the selected subset complies with the RAB limitation requirement. Finally, any RAB of the set of RABs which is not in the selected subset is released, whereas any RAB of the set of RABs which is in the selected subset is kept.

The above-mentioned RAB limitation requirement may define a maximum number of RABs. For instance, the RAB limitation requirement may be a requirement that sets a limitation on the number of RABs that can be set up.

In some embodiments, any RAB which is not in the selected subset does not have a ranking which is higher than that of a RAB which is in the selected subset.

In one embodiment, the determination of the ranking for each RAB of the set of RABs comprises assigning a ranking value to each RAB on the basis of said generated predicted timing such that the shorter the predicted timing of a next data transmission is, the higher is the assigned ranking value. In one embodiment, the selection of the subset of the set of RABs comprises selecting those one or more RABs having the highest ranking values.

In one embodiment, which is particularly advantageous for WCDMA, the method additionally comprises determining that the UE will be ordered from one Radio Resource Control (RRC) state that is supporting a certain number of RABs to another RRC state that is supporting a comparatively fewer number of RABs.

The earlier-mentioned information related to each RAB of the set of RABs may comprise one or more of the following: traffic information, quality of service information, UE type information, user class information, service and/or application information.

In some embodiments, the method comprises obtaining information about the RAB limitation requirement from an internal memory of the radio network node. Additionally, or alternatively, the method may comprise receiving a data message from another node, the data message comprising a data field including information about the RAB limitation requirement.

The method is advantageously applied in WCDMA. If applied in WCDMA, the radio network node may be a RNC. However, the method can alternatively be applied in LTE. When the method is applied in LTE, the radio network node may be an evolved NodeB (eNB). Also, the RAB may be an Evolved Universal Terrestrial Radio Access Network (E-UTRAN) RAB, commonly known as an E-RAB.

In another of its aspects, the technology disclosed herein concerns a radio network node for controlling RAB release. The radio network node is configured to handle a set of RABs. Or said differently, the radio network node can be said to be configured to handle a number of UEs, where each UE has an associated set of RABs. Thus, the radio network node can be said to be configured to handle a set of RABs. The set of RABs consists of one or more RABs for providing communication service to a UE. The radio network node comprises a processor and a memory. The memory comprises instructions executable by the processor, whereby the radio network node is operative to obtain information related to each RAB of the set of RABs, process the obtained information to generate a predicted timing of a next data transmission for each RAB of the set of RABs, determine a ranking for each RAB of the set of RABs based on the generated predicted timing, selecting (based on the determined ranking) a subset of the set of RABs such that a cardinality of the selected subset complies with a RAB limitation requirement, release any RAB of the set of RABs which is not in the selected subset, and keep any RAB of the set of RABs which is in the selected subset.

Again, the RAB limitation requirement may define a maximum number of RABs. For example, the RAB limitation requirement may be a requirement that sets a limitation on the number of RABs that can be set up.

In some embodiments, any RAB which is not in the selected subset does not have a ranking which is higher than that of a RAB which is in the selected subset.

In one embodiment, the memory comprises instructions executable by the processor whereby the radio network node is operative to assign a ranking value to each RAB on the basis of said generated predicted timing such that the shorter the predicted timing of a next data transmission is, the higher is the assigned ranking value. The memory may also comprise instructions executable by the processor whereby the radio network node is operative to select those one or more RABs having the highest ranking values.

In one embodiment, which is particularly advantageous for WCDMA, the memory additionally comprises instructions executable by the processor whereby the radio network node is operative to determine that the UE will be ordered from one RRC state that is supporting a certain number of RABs to another RRC state that is supporting a comparatively fewer number of RABs.

The above-mentioned information related to each RAB of the set of RABs may comprise one or more of the following: traffic information, quality of service information, UE type information, user class information, service and/or application information.

In some embodiments, the memory comprises instructions executable by said processor, whereby the radio network node is operative to obtain information about the RAB limitation requirement from an internal memory of the radio network node.

In some embodiments, the radio network node comprises a receiver configured to receive a data message from another node, the data message comprising a data field including information about the RAB limitation requirement.

The radio network node may be an RNC (e.g. in WCDMA). Alternatively, the radio network node may be an eNB (e.g. in LTE). Thus, in some embodiments, the RAB may be an E-RAB.

The various embodiments provide an improved RAB release, particularly in scenarios when there exists a RAB limitation requirement. In WCDMA, an example of such a scenario is when the UE is ordered to make a state switch from one RRC state supporting a certain number of RABs to another RRC state supporting a comparatively lower number of RABs. In LTE, an example of such a scenario is when a new RAB is to be established and, at the same time, the total number of supported RABs for either or both of the eNB and the UE is exceeded. This latter LTE example or scenario is, by the way, also valid in e.g. WCDMA. By ranking each RAB of a set of RABs based on a predicted timing of a next data transmission it is made possible to make an improved selection as to which RAB(s) to release and which RAB(s) to keep in situations when there exists a RAB limitation requirement. In turn, the improved selection of which RAB(s) to keep and release, respectively, allows for avoiding (or at least reducing the risk of) a selection where improper RAB(s) are kept. Too much unnecessary latency and/or signaling may thus be avoided.

### BRIEF DESCRIPTION OF THE DRAWINGS

These and other aspects, features and advantages will be apparent and elucidated from the following description of various embodiments, reference being made to the accompanying drawings, in which:

FIG. 1A shows an example network architecture for UTRAN;

FIG. 1B shows an example network architecture for E-UTRAN;

FIGS. 2A-C are flowcharts of example methods according to various embodiments;

FIG. 3 shows a schematic prediction engine for the prediction of a next data transmission on a per-RAB basis;

FIG. 4 is an example embodiment of a radio network node for performing any of the methods of FIGS. 2A-C; and

FIG. 5 is another example embodiment of a radio network node for performing any of the methods of FIGS. 2A-C.

### DETAILED DESCRIPTION

The present invention will now be described more fully hereinafter with reference to the accompanying drawings, in which certain embodiments are shown. The invention may, however, be embodied in many different forms and should not be construed as limited to the embodiments set forth herein; rather, these embodiments are provided by way of example so that this disclosure will be thorough and complete, and will fully convey the scope of the technology to those persons skilled in the art. Like reference numbers refer to like elements or method steps throughout the description.

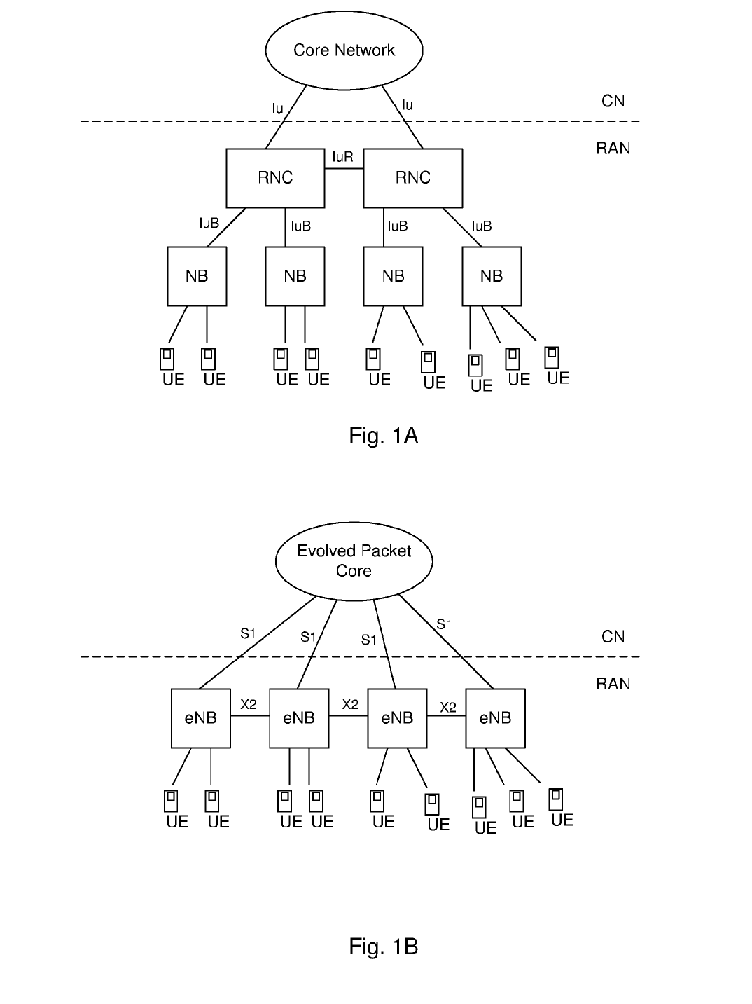

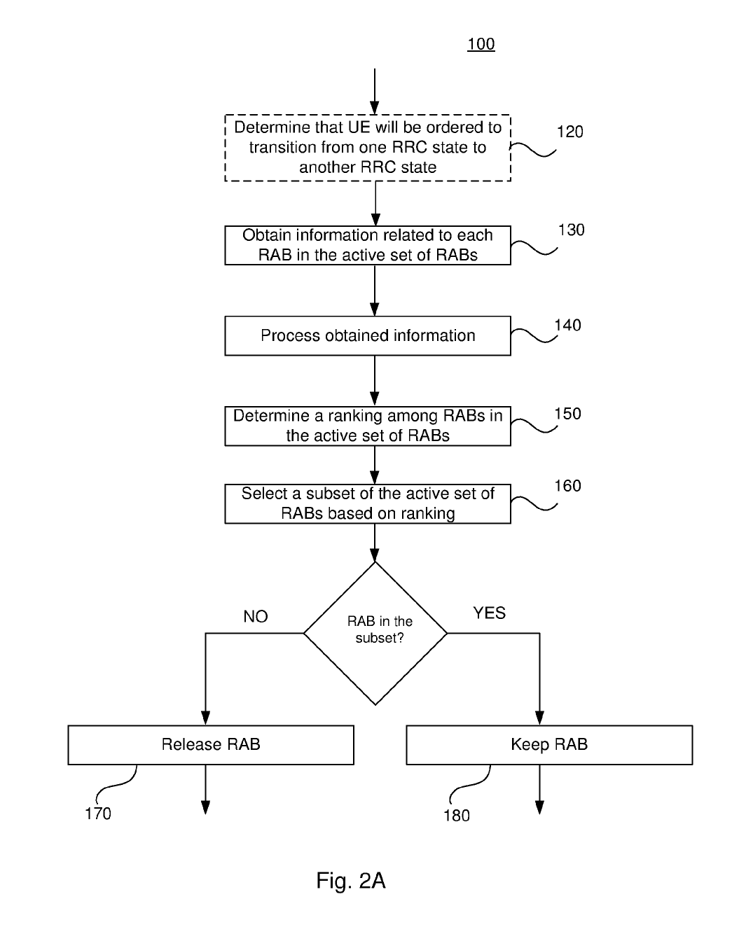

A method aimed at improving RAB release is suggested herein. The method is advantageously applied in situations when there exist a RAB limitation requirement, e.g. a requirement that sets a limitation on the number of RABs that can be set up. With reference to FIGS. 2A-C, a method 100 for controlling RAB release is illustrated. The method 100 is performed by, or otherwise executed in, a radio network node. As will be further detailed herein, the method can advantageously be applied in WCDMA (see e.g. FIG. 1A). When applied in WCDMA, the radio network node may be a RNC. Alternatively, the method can be applied in LTE (see e.g. FIG. 1B). When applied in LTE, the radio network node may be an eNB.

The radio network node is configured to handle a set of RABs. The set of RABs typically consists of one or several RABs for providing communication service to a UE. Or said differently, the radio network node can be said to be configured to handle a number of UEs, where each UE has an associated set of RABs. Thus, the radio network node is configured to handle a set of RABs.

As can be seen in FIG. 2A, information related to each RAB of the set of RABs is obtained 130 (e.g. collected, acquired, or received). In some embodiments, the information of the RAB limitation requirement is obtained e.g. retrieved, from an internal memory of the radio network node. In other embodiments, the radio network node may receive a data message from another node of the radio communication network, wherein the data message comprises a data field including the information about the RAB limitation requirement. In yet other embodiments, the information of the RAB limitation requirement can be collected from a combination of retrieval from an internal memory of the radio network node and reception of data message(s) from other radio network nodes.

The thus obtained information is processed 140 to generate a predicted timing of a next data transmission for each RAB of the set of RABs. Various examples on how to predict the timing of a next data transmission will be discussed later in this disclosure.

Also, a ranking is determined 150 for each RAB of the set of RABs. This ranking is determined based on the earlier-mentioned predicted timing.

Furthermore, a subset of the set of RABs is selected 160 based on the determined ranking. The subset of the set of RABs is selected in such way that a cardinality of the selected subset complies with a RAB limitation requirement. Or said differently, the subset of the set of RABs is selected in such way that a number of RABs of the selected subset complies with the RAB limitation requirement. The RAB limitation requirement may define a maximum number of RABs. For instance, the RAB limitation requirement may be a requirement that sets a limitation on the number of RABs that can be set up.

Subsequently, any RAB of the set of RABs which is not in the selected subset is released 170, whereas any RAB of the set of RABs which is in the selected subset is kept 180.

It should be appreciated that there exist various ways of realizing the ranking determination 150 and the subsequent selection 160, which is based on the determined ranking. With reference to FIGS. 2B-2C, one example embodiment is illustrated. According to this example embodiment, a ranking value is assigned 151 to each RAB on the basis of the predicted timing that was generated when the obtained information was processed 140. The ranking value is assigned 151 in such a manner that the shorter the predicted timing of a next data transmission is, the higher is the assigned ranking value. Likewise, the longer the predicted timing of a next data transmission is, the lower is the assigned ranking value. Turning now to FIG. 2C, those one or more RABs having the highest ranking values are selected 161. This means that those RAB(s) having the shortest predicted timing of a next data transmission are selected. In other words, the RAB(s) that is/are considered being the “best” RAB(s) is/are selected. In this regard, it should be remembered that the exact number of RABs that can be selected 161 is stipulated, or determined, by the earlier-mentioned RAB limitation requirement. In this regard, it should further be appreciated that it is in fact not necessary to assign ranking values when determining a ranking. For example, it may suffice to determine that the shorter the predicted timing, the higher is the ranking. This would mean that a RAB has a higher ranking than another RAB if (and only if) its predicted timing is shorter than that of another RAB. In other words, assigning a ranking value and making the selection of the RAB(s) based on assigned ranking values may be advantageous, but not at all necessary for carrying out the ranking and the selection based on the ranking.

The method described with reference to FIGS. 2A-2C provide an improved RAB release, which is particularly advantageous in scenarios when there exists a RAB limitation requirement.

In WCDMA, an example of such a scenario is when the UE is ordered to make a state switch (e.g. state change) from one RRC state supporting a certain number of RABs to another RRC state supporting a comparatively lower number of RABs. Therefore, for the WCDMA application, the method 100 may advantageously also comprise determining 120 that the UE will be ordered from one RRC state that is supporting a certain number of RABs to another RRC state that is supporting a comparatively fewer number of RABs. Techniques for determining that the UE will be ordered from one RRC state to another are known to persons skilled in the art and will therefore not be further detailed herein.

In LTE, an example of such a scenario is when a new E-RAB is to be established and, at the same time, the total number of supported E-RABs for either or both of the eNB and the UE is exceeded.

By ranking each RAB of a set of RABs based on a predicted timing of a next data transmission it is made possible to make an improved selection as to which RAB(s) to release and which RAB(s) to keep in situations when there exists a RAB limitation requirement. In turn, the improved selection of which RAB(s) to keep and release, respectively, allows for avoiding (or at least reducing the risk of) a selection where improper RAB(s) are kept. Too much unnecessary latency and/or signaling can thus be avoided.

### Prediction of the Timing of a Next Data Transmission

As mentioned earlier, there exist various techniques for predicting the timing of a next data transmission. These techniques are known to persons skilled in the art and are described briefly herein only for the purpose of facilitating the understanding of the various embodiments.

The prediction of the timing of a next data transmission can be made using known machine-learning algorithms. Typical input data for the prediction include traffic information such as inter arrival times between packets, packet sizes, burst sizes, etc. This input data may be acquired, e.g. collected, either continuously or at predetermined intervals. Also, it would be conceivable to acquire the information applying a sliding window principle. By sliding window is meant a prediction window. Statistics and similar information or data can be collected during this prediction window, which is essentially a time window, or time period. The prediction of the next data transmission can be done by a statistical analysis of the data collected within the time window.

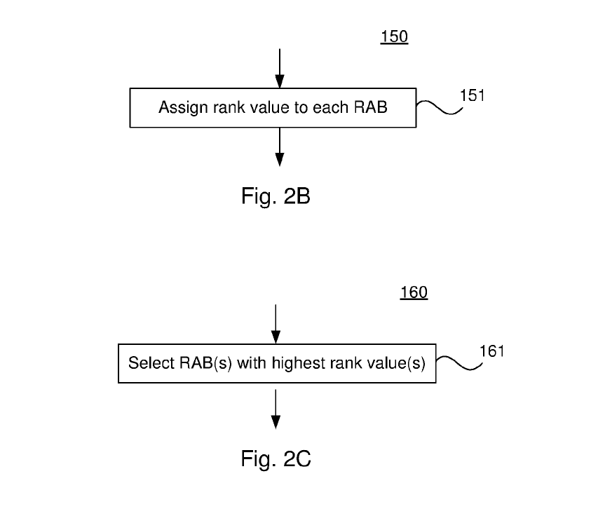

Examples of machine-learning algorithms that can be used for the prediction include e.g. neural network, Wavelet network, a decision tree learning, etc. Again, data message features such as inter arrival times between packets, packet sizes, burst sizes, etc that describe the traffic patterns can be used as the basis, or input, for the predictions. FIG. 3 schematically shows a prediction model for the prediction of a next data transmission of a next data transmission on a per-RAB basis.

### Additional Possible Decision Criteria

Turning back to FIG. 2, it should be appreciated that decision as to which RAB(s) to keep and which RAB(s) to release may additionally, or alternatively, be based on other criteria, some of which will be briefly described here.

One possible parameter to utilize is quality of service information, i.e. information about what service that is carried on the different RABs. The service information may be retrieved by packet inspection in RAN or in the core network and sent to RAN, e.g. piggy backed on the data packets. Certain services may have a known repetitive traffic pattern, where it is thus relatively easy to foresee the next packet arrival given a longer period of inactivity. One way to do this would be to map a certain packet inter arrival time information to each service. This packet inter arrival time may e.g. be obtained by analysis and statistics of the different services in advance. The service information may also be used as an input to the predictions of the arrival time of the next packet (see FIG. 3). This would give information to the prediction engine, or prediction model, about the nature of the traffic pattern.

Another possible parameter to utilize is the latency requirements of the services mapped to the different RABs. The RAB carrying the most delay sensitive service could then be kept when switching from a RRC state supporting a higher number of RABs to a RRC state supporting a lower number of RABs. This parameter can be retrieved from Quality of Service (QoS) parameters for that specific RAB. For more elaborated decisions, the QoS information may be combined with service information from e.g. packet inspection.

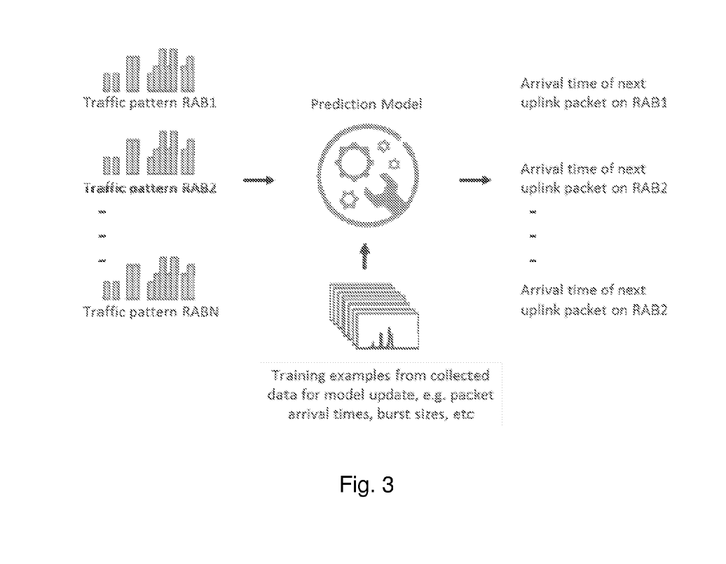

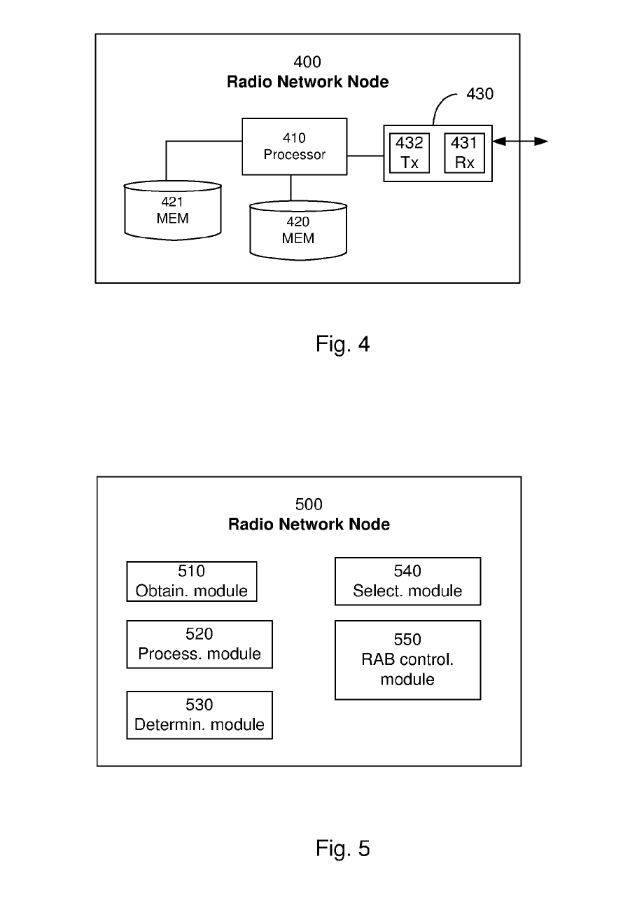

The method described with reference to FIGS. 2A-2C can be implemented in various ways. FIG. 4 illustrates one embodiment where the method is performed, or otherwise implemented in, a radio network node 400. If applied in WCDMA, the radio network node 400 may e.g. be implemented as an RNC. Alternatively, if applied in LTE the radio network node 400 may be an eNB. Also, if applied in LTE the RABs described hereinbelow may be so-called E-RABs.

The radio network node 400 is configured to handle a set of RABs, wherein the set of RABs consists of one or more RABs for providing communication service to a UE. The radio network node 400 comprises means for obtaining information related to each RAB of the set of RABs, means for processing the obtained information to generate a predicted timing of a next data transmission for each RAB of the set of RABs, means for determining a ranking for each RAB of the set of RABs based on said predicted timing, means for selecting (based on the determined ranking) a subset of the set of RABs such that a cardinality of the selected subset complies with a RAB limitation requirement, means for releasing any RAB of the set of RABs which is not in the selected subset, and means for keeping any RAB of the set of RABs which is in the selected subset. In the example implementation of FIG. 4., the radio network node 400 comprises a processor 410 and a memory 420 wherein said memory 420 comprises instructions executable by said processor 410, whereby said radio network node 400 is operative to: obtain information related to each RAB of the set of RABs; process the obtained information to generate a predicted timing of a next data transmission for each RAB of the set of RABs; determine a ranking for each RAB of the set of RABs based on said generated predicted timing; selecting, based on the determined ranking, a subset of the set of RABs such that a cardinality of the selected subset complies with a RAB limitation requirement; release any RAB of the set of RABs which is not in the selected subset; and keep any RAB of the set of RABs which is in the selected subset.

Any RAB which is not in the selected subset does not have a ranking which is higher than that of a RAB which is in the selected subset.

In one embodiment, the memory 420 comprises instructions executable by the processor 410, whereby the radio network node 400 is operative to assign a ranking value to each RAB on the basis of said generated predicted timing such that the shorter the predicted timing of a next data transmission is the higher is the assigned ranking value. The memory 420 may also comprise instructions executable by the processor 410 whereby the radio network node 400 is operative to select those one or more RABs having the highest ranking values. Again, and as stated earlier, it is not necessary to assign a ranking value.

In some embodiments, e.g. those applied in WCDMA, the memory 420 may additionally comprise instructions executable by the processor 410, whereby the radio network node 400 is operative to determine that the UE will be ordered from one RRC state that is supporting a certain number of RABs to another RRC state that is supporting a comparatively fewer number of RABs.

As mentioned earlier in this disclosure, the information related to each RAB of the set of RABs may comprises one or more of the following: traffic information, quality of service information, UE type information, user class information, service and/or application information.

In some embodiments, the memory 420 comprises instructions executable by the processor 410 whereby the radio network node 400 is operative to obtain information about the RAB limitation requirement from an internal memory 421 of the a radio network node 400. Additionally, or alternatively, the radio network node 400 may comprise a receiver 431 configured to receive a data message from another node, wherein the data message comprising a data field including information about the RAB limitation requirement. The receiver 431 may be part of a communication interface, or communication module 430. The communication module 430 may additionally comprise a transmitter 432. The receiver 431 and the transmitter 432 can be implemented separately or, alternatively, in one single module such as a transceiver.

In yet another implementation example, a radio network node 500 for implementing the method described with reference to FIGS. 2A-2C is provided. This radio network node 500 handles a set of RABs, wherein the set of RABs consists of one or more RABs for providing communication service to a UE. This radio network node 500 comprises an information obtaining module 510 for obtaining information related to each RAB of the set of RABs. Furthermore, a processing module 520 is provided for processing the obtained information to generate a predicted timing of a next data transmission for each RAB of the set of RABs. Also, a determination module 530 is provided for determining a ranking for each RAB of the set of RABs based on said predicted timing. The radio network node 500 also comprises a selection module 540 for selecting, based on the determined ranking, a subset of the set of RABs such that a cardinality of the selected subset complies with a RAB limitation requirement. A RAB controlling module 550 is provided for releasing any RAB of the set of RABs which is not in the selected subset and for keeping any RAB of the set of RABs which is in the selected subset.

The various embodiments described in this disclosure provide an improved RAB release, particularly in scenarios when there exists a RAB limitation requirement. By ranking each RAB of a set of RABs based on a predicted timing of a next data transmission it is made possible to make an improved selection as to which RAB(s) to release and which RAB(s) to keep in situations when there exists a RAB limitation requirement. In turn, the improved selection of which RAB(s) to keep and release, respectively, allows for avoiding (or at least reducing the risk of) a selection where improper RAB(s) are kept. Unnecessary latency and/or signaling may thus be avoided, or reduced.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Modifications and other variants of the described embodiments will come to mind to one skilled in the art having benefit of the teachings presented in the foregoing description and associated drawings. Therefore, it is to be understood that the embodiments are not limited to the specific example embodiments disclosed and that modifications and other variants are intended to be included within the scope of this disclosure. Although specific terms may be employed herein, they are used in a generic and descriptive sense only and not for purposes of limitation. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1-22. (canceled)

23. A method for controlling Radio Access Bearer (RAB) release performed by a radio network node, the radio network node handling a set of RABs, wherein the set of RABs consists of one or more RABs for providing communication service to a User Equipment (UE) the method comprising:
obtaining information related to each RAB of the set of RABs;
processing the obtained information to generate a predicted timing of a next data transmission for each RAB of the set of RABs;
determining a ranking for each RAB of the set of RABs based on said predicted timing;
selecting, based on the determined ranking, a subset of the set of RABs such that a cardinality of the selected subset complies with a RAB limitation requirement;
releasing any RAB of the set of RABs which is not in the selected subset; and
keeping any RAB of the set of RABs which is in the selected subset.

24. The method according to claim 23, wherein any RAB which is not in the selected subset does not have a ranking which is higher than that of a RAB which is in the selected subset.

25. The method according to claim 23, wherein determining a ranking for each RAB of the set of RABs comprises:
assigning a ranking value to each RAB on the basis of said generated predicted timing such that the shorter the predicted timing of a next data transmission is the higher is the assigned ranking value.

26. The method according to claim 25, wherein selecting, based on the determined ranking, comprises:
selecting those one or more RABs having the highest ranking values.

27. The method according to claim 23, further comprising:
determining that the UE will be ordered from one Radio Resource Control (RRC) state that is supporting a certain number of RABs to another RRC state that is supporting a comparatively fewer number of RAB s.

28. The method according to claim 23, wherein the RAB is an Evolved Universal Terrestrial Radio Access Network (E-UTRAN) RAB.

29. The method according to claim 23, wherein the information related to each RAB of the set of RABs comprises one or more of the following: traffic information, quality of service information, UE type information, user class information, service and/or application information.

30. The method according to claim 23, comprising:
obtaining information about the RAB limitation requirement from an internal memory of the radio network node.

31. The method according to claim 23, comprising:
receiving a data message from another node, the data message comprising a data field including information about the RAB limitation requirement.

32. The method according to claim 23, wherein the RAB limitation requirement defines a maximum number of RABs.

33. A radio network node for controlling Radio Access Bearer (RAB) release, the radio network node being configured to handle a set of RABs, wherein the set of RABs consists of one or more RABs for providing communication service to a User Equipment (UE) wherein the radio network node comprises:
a processor, and
a memory, wherein said memory comprises instructions executable by said processor, whereby said radio network node is operative to: obtain information related to each RAB of the set of RABs; process the obtained information to generate a predicted timing of a next data transmission for each RAB of the set of RABs; determine a ranking for each RAB of the set of RAB s based on said generated predicted timing; selecting, based on the determined ranking, a subset of the set of RABs such that a cardinality of the selected subset complies with a RAB limitation requirement; release any RAB of the set of RABs which is not in the selected subset; and keep any RAB of the set of RABs which is in the selected subset.

34. The radio network node according to claim 33, wherein any RAB which is not in the selected subset does not have a ranking which is higher than that of a RAB which is in the selected subset.

35. The radio network node according to claim 33, wherein said memory comprises instructions executable by said processor, whereby said radio network node is operative to assign a ranking value to each RAB on the basis of said generated predicted timing such that the shorter the predicted timing of a next data transmission is the higher is the assigned ranking value.

36. The radio network node according to claim 35, wherein said memory comprises instructions executable by said processor, whereby said radio network node is operative to select those one or more RABs having the highest ranking values.

37. The radio network node according to claim 33, wherein said memory comprises instructions executable by said processor, whereby said radio network node is operative to determine that the UE will be ordered from one Radio Resource Control (RRC) state that is supporting a certain number of RABs to another RRC state that is supporting a comparatively fewer number of RABs.

38. The radio network node according to claim 33, wherein the RAB is an Evolved Universal Terrestrial Radio Access Network (E-UTRAN) RAB.

39. The radio network node according to claim 33, wherein the information related to each RAB of the set of RABs comprises one or more of the following: traffic information, quality of service information, UE type information, user class information, service and/or application information.

40. The radio network node according to claim 33, wherein said memory comprises instructions executable by said processor, whereby said radio network node is operative to obtaining information about the RAB limitation requirement from an internal memory of the radio network node.

41. The radio network node according to claim 33, comprising a receiver configured to receive a data message from another node, the data message comprising a data field including information about the RAB limitation requirement.

42. The radio network node according to claim 33, wherein the RAB limitation requirement defines a maximum number of RABs.

43. The radio network node according to claim 33, wherein the radio network node is a Radio Network Controller, RNC.

44. The radio network node according to claim 33, wherein the radio network node is an evolved NodeB (eNB).
